(19) United States
(12) Patent Application Publication
(10) Pub. No.: US 2014/0134403 A1
(43) Pub. Date: May 15, 2014

(54) INTERFACE MODIFICATION OF POLYCRYSTALLINE DIAMOND COMPACT

(71) Applicant: DIAMOND INNOVATIONS, INC., Worthington, OH (US)

(72) Inventor: Andrew Gledhill, Westerville, OH (US)

(73) Assignee: DIAMOND INNOVATIONS, INC., Worthington, OH (US)

(21) Appl. No.: 13/673,440

(22) Filed: Nov. 9, 2012

(51) Int. Cl. E21B 10/567; B32B 3/30; B32B 9/00

(52) U.S. Cl. CPC E21B 10/567; B32B 9/007; B32B 3/30
USPC 428/172; 428/332; 428/156; 252/182.32

(57) ABSTRACT

A cutting element and a method of providing the cutting element are provided. The cutting element may comprise a substrate, a first polycrystalline diamond zone, and a second polycrystalline diamond zone. The first polycrystalline diamond zone may have substantially free of a catalyst material. The second polycrystalline diamond zone rich in the catalyst material may be bonded to the substrate along an interface. The second polycrystalline diamond zone may be bonded to the first polycrystalline diamond zone along an effective transition zone. The effective transition zone may have a plurality of irregular projections toward the first polycrystalline diamond zone and the second polycrystalline diamond zone.

### BACKGROUND OF THE INVENTION

The present disclosure relates to polycrystalline diamond materials, and, more specifically, to polycrystalline composites and compacts which are substantially free of a catalyzing material that have greatly improved impact resistance while maintaining excellent wear resistance.

It has become well known that the cutting properties of the polycrystalline diamond materials are greatly enhanced when a relatively thin layer of the diamond material adjacent to a working surface is treated to remove the catalyzing material that remains there from the manufacturing process. This has been a relatively thin layer, generally from about 0.05 mm to about 0.4 mm thick, and the depth from the working surface tends to be generally uniform. This type of polycrystalline diamond cutting element has now become nearly universally used as cutting elements in earth boring drill bits and has caused a very significant improvement in drill bit performance.

Because these surfaces tend to be planar, however, it has been observed that fracture adjacent to the treated layer may occur. It has been speculated that the often lenticular type of fracture may be related to stresses that form in the area between the depleted and non-depleted regions. It is believed that stress concentrations in this ‘transition’ region may lead to these fractures.

Therefore, there is a need for new approaches to the fabrication of polycrystalline composites and compacts with better performance.

### SUMMARY OF THE INVENTION

In one embodiment of the present invention, a cutting element comprises: a first polycrystalline element zone having substantially free of a catalyst material; a second polycrystalline element zone rich in the catalyst material; and an effective transition zone sandwiched between the first polycrystalline element zone and the second polycrystalline element zone, wherein the effective transition zone ranges from about 50 to about 120 microns.

In another embodiment, a method comprises subjecting diamond crystal to a high pressure and high temperature condition in the presence of a catalyst material to form a polycrystalline diamond material; and treating the polycrystalline diamond material to remove a portion of the catalyst material to form a polycrystalline diamond body that has an effective transition zone sandwiched between a first polycrystalline diamond zone having substantially free of a catalyst material and a second polycrystalline element zone rich in the catalyst material, wherein the effective transition zone has a plurality of irregular projections toward the first polycrystalline element zone and the second polycrystalline element zone.

In still another embodiment, a cutting element comprises: a substrate, a first polycrystalline diamond zone having substantially free of a catalyst material; a second polycrystalline diamond zone bonded to the substrate along an interface, wherein the second polycrystalline diamond zone bonded to the first polycrystalline diamond zone along an effective transition zone, wherein the effective transition zone has a plurality of irregular projections toward the first polycrystalline diamond zone and the second polycrystalline diamond zone.

### BRIEF DESCRIPTION OF THE DRAWINGS

The foregoing summary, as well as the following detailed description of the embodiments, will be better understood when read in conjunction with the appended drawings. It should be understood that the embodiments depicted are not limited to the precise arrangements and instrumentalities shown.

FIG. 1 is schematic perspective view of a cylindrical shape PDC cutting element produced in a HPHT process according to an exemplary embodiment;

FIG. 2 is a schematic cross-sectional view of a machined PDC cutter comprising a polycrystalline diamond and a substrate according to another exemplary embodiment;

FIG. 3 is a schematic flow diagram illustrating a method of making a PDC cutter with an effective transition zone according to an exemplary embodiment;

FIG. 4A is a scanning electron microscope (SEM) in back scattered electron mode of a polycrystalline diamond cutter made by a conventional method;

FIG. 4B is a scanning electron microscope (SEM) in back scattered electron mode of a polycrystalline diamond cutter made by an exemplary embodiment; and

FIG. 5 is a scanning electron microscope (SEM) in back scattered electron mode of a polycrystalline diamond cutter made by another exemplary embodiment.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope. For example, as used herein, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

Unless otherwise indicated, all numbers expressing quantities of ingredients, properties such as size, weight, reaction conditions and so forth used in the specification and claims are to the understood as being modified in all instances by the term “about”. Accordingly, unless indicated to the contrary, the numerical parameters set forth in the following specification and attached claims are approximations that may vary depending upon the desired properties sought to be obtained by the invention. At the very least, and not as an attempt to limit the application of the doctrine of equivalents to the scope of the claims, each numerical parameter should at least be construed in light of the number of reported significant digits and by applying ordinary rounding techniques.

As used herein, the term “about” means plus or minus 10% of the numerical value of the number with which it is being used. Therefore, about 50% means in the range of 45%-55%. When the term, “substantially free”, is used referring to catalyst in interstices, interstitial matrix, or in a volume of polycrystalline element body, such as polycrystalline diamond, it should be understood that many, if not all, the surfaces of the adjacent diamond crystals may still have a coating of the catalyst. Likewise, when the term “substantially free” is used referring to catalyst on the surfaces of the diamond crystals, there may still be catalyst present in the adjacent interstices.

The term “effective transition zone (ETZ)”, means the length between the highest peak of a plurality of projections toward substantially leached polycrystalline element zone and the lowest valley of the plurality of projections toward rich in catalyst polycrystalline element zone.

Broadly, a cutting element may include ultra-hard particles. The ultra-hard particles may be those commonly used in the art and include, for example, diamond, cubic boron nitride and the like. The hardness of these particles is commonly a Knoop hardness number of 5,000 KHN or greater. In one exemplary embodiment, a cutting element may be a polycrystalline element, such as polycrystalline diamond (PDC), polycrystalline diamond composite, polycrystalline cubic boron nitride (PcBN). In exemplary embodiments, polycrystalline diamond composite may represent a volume of crystalline diamond grains with embedded foreign material filling the inter-grain space. In one particular case, composite comprises crystalline diamond grains, bonded to each other by strong diamond-to-diamond bonds and forming a rigid polycrystalline diamond body, and the inter-grain regions, disposed between the bonded grains and filled with a catalyst material (e.g. cobalt or its alloys), which was used to promote diamond bonding during fabrication. Suitable metal solvent catalysts may include the metal in Group VIII of the Periodic table.

The cutting element comprises an above mentioned polycrystalline diamond body attached to a suitable support substrate, e.g. cobalt cemented tungsten carbide (WC—Co), by the virtue of the presence of cobalt metal. In another exemplary embodiment, polycrystalline diamond composite comprises a plurality of crystalline diamond grains, which are not bonded to each other, but instead are bonded together by foreign bonding materials such as borides, nitrides, carbides, etc. (e.g. SiC).

Polycrystalline diamond composites and the cutting element may be fabricated in different ways and the following examples do not limit a variety of different types of diamond composites and cutters. In one exemplary embodiment, cutters are formed by placing a mixture of diamond polycrystalline powder with a suitable solvent catalyst material (e.g. cobalt) presented in WC—Co substrate. The assembly is subjected to processing conditions of extremely high pressure and high temperature (HPHT), where the solvent catalyst promotes desired inter-crystalline diamond-to-diamond bonding and, also, provides a binding between polycrystalline diamond body and substrate support. In another exemplary embodiment, the cutter is formed by placing diamond powder without a catalyst material on the top of substrate containing a catalyst material (e.g. WC—Co substrate or WC—Co substrate and an additional thin cobalt disk facing the diamond powder). In this example, necessary cobalt catalyst material is supplied from the substrate and melted cobalt is swept through the diamond powder during the HPHT process. In still another exemplary embodiment, a hard polycrystalline diamond composite is fabricated by forming a mixture of diamond powder with silicon powder and mixture is subjected to HPHT process, thus forming a dense polycrystalline compact where diamond particles are bonded together by newly formed SiC material.

Abrasion resistance of polycrystalline diamond composites and PDC cutters may be determined mainly by the strength of bonding between diamond particles (e.g. cobalt catalyst), or, in the case when diamond-to-diamond bonding is absent, by foreign material working as a binder (e.g. SiC binder), or in still another case, by both diamond-to-diamond bonding and foreign binder. Presence of catalyst inside the polycrystalline diamond body of the cutter promotes the degradation of cutting edge of the cutter during the cutting process, especially if the edge temperature reaches a high enough critical value. Probably, this cobalt driven degradation is caused by large difference in thermal expansion between diamond and catalyst (e.g. cobalt metal), and also by catalytic effect of cobalt on diamond graphitization. Removal of catalyst from the polycrystalline diamond body of the cutter, for example, by chemical etching in acids, leaves interconnected network of pores and a residual catalyst (up to 10 vol %) trapped inside the polycrystalline diamond body. It has been demonstrated in previous art that removal of cobalt from PDC cutter significantly improves its abrasion resistance.

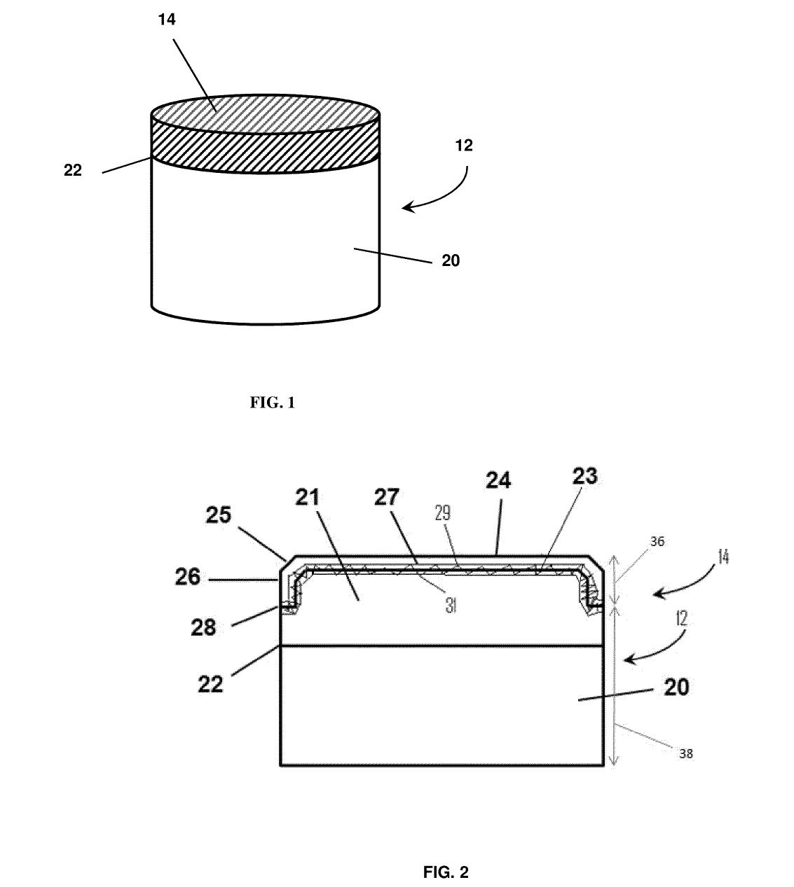

FIG. 1 shows schematic perspective view of a cutting element, such as common cylindrical shape PDC cutting element 12 produced in a HPHT process with a catalyst. Common PDC cutting element 12 comprises: a substrate 20, which is made of hard metal, alloy, or composite, and most typically of cemented carbide or cobalt sintered tungsten carbide (WC—Co); and a polycrystalline diamond composite volume 14 rich in catalyst after the HPHT process, and attached or joined coherently to the substrate along the interface 22. Very often, such catalyst as cobalt metal or its alloys may be present as a diamond bond forming aid in HPHT manufacture of the polycrystalline diamond volume 14. PDC cutter element 12 may be later machined to a desired shape.

FIG. 2 shows a cross-sectional view of an exemplary embodiment of a cutting element, such as a PDC cutter 12, a planar upper surface 24, a chamfer 25, and a side surface 26. As it is appreciated, the shape of PDC cutter described here does not limit the scope of current disclosure and PDC cutters may have a variety of shapes. Thus, in an exemplary embodiment, the surface of machined PDC cutter 12 may be treated in a mixture of acids in order to remove a surface layer of a catalyst. The cutting element 12 may include a first polycrystalline element zone 27, a second polycrystalline element zone 21, and an effective polycrystalline element zone 28. The first polycrystalline element zone 27 may have substantially free of a catalyst material. The second polycrystalline element zone 21 may be rich in a catalyst material.

The substrate 20, such as a cemented carbide substrate, for example, may be configured to attach to the second polycrystalline element zone 21. The catalyst material may be present as a sintering aid in manufacture of the first and the second polycrystalline element zones 27 and 21, respectively. The sintering aid may be a member selected from a group comprising of cobalt, nickel, and iron, for example. The first or second polycrystalline element zone 27 and 21 may comprise a material selected from a group of polycrystalline cubic boron nitride, polycrystalline diamond and polycrystalline diamond like materials, such as polycrystalline diamond doped with elements selected from a group comprising of N, B, P, Si, and S.

The diamond cutter 12 may comprise: the first polycrystalline element zone 27 depleted in cobalt to a necessary one or several depths from, correspondingly: an outer peripheral upper surface 24, chamfer 25, or an outer peripheral side surface 26 of the polycrystalline diamond composite volume 21 rich in catalyst material, wherein the first polycrystalline element zone 27 extends along the side surface 26 to the effective transition zone 28 with the second polycrystalline element zone 21, but does not reach the interface 22 with the substrate 20. In particular cases, the first polycrystalline element zone 27 may extend away from an upper surface 24 to a first predetermined depth, from a chamfer 25 to a second predetermined depth, and from a side surface 26 to a third predetermined depth.

For example, each depletion depth, as they were described above, may be from about 10 μm to about 500 μm, or it could be from about 2 μm to about 60 μm, for example. Also, for example, a third depletion depth may constitute of at least half of the overall thickness of the polycrystalline diamond volume 21, but stops short of the interface 22 by at least about 500 μm, for example.

Acid treated PDC cutter 12 may be taken out from hot acid bath, and cleaned in water to remove acid from the cutter 12. The interface between the first polycrystalline element zone 27 and the second polycrystalline element zone 21 may be substantially linear as shown in a line 23 in FIG. 2 under conventional acid treatment. In an exemplary embodiment, the effective transition zone 28 may exist between the first polycrystalline element zone 27 and the second polycrystalline element zone 21. The effective transition zone 28 may be sandwiched between the first polycrystalline element zone 27 and the second polycrystalline element zone 21. The effective transition zone 28 may range from about 50 to about 120 microns, for example.

The effective transition zone 28 comprises a plurality of irregular projections 29 and 31 toward the first polycrystalline element zone 27 and the second polycrystalline element zone 21, respectively.

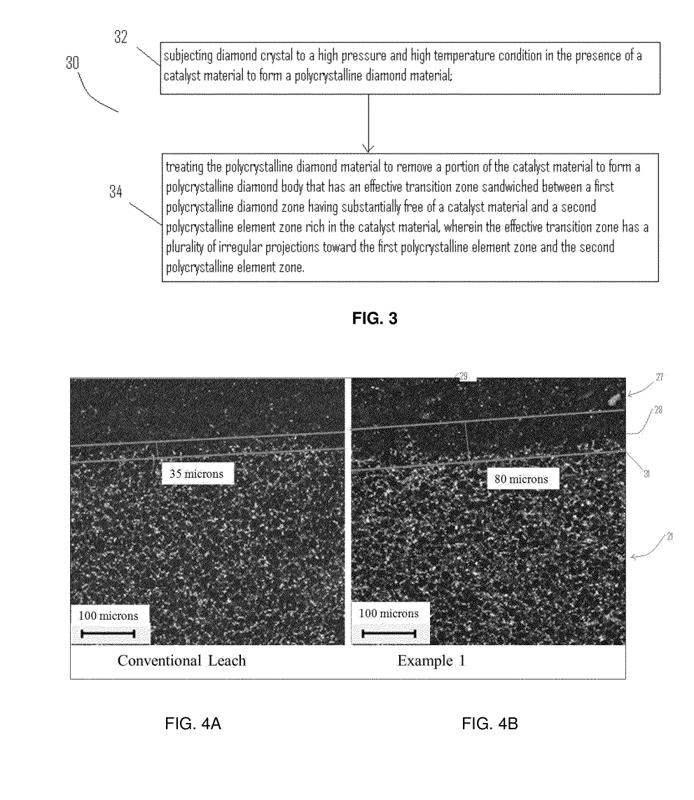

FIG. 3 illustrates a method of leaching a PDC cutting element according to an exemplary embodiment. In a step 32, a plurality of diamond crystals may be subjected to a high pressure and high temperature (HPHT). More specifically, the plurality of diamond crystals may be loaded into a high pressure/high temperature cell and pressed in a belt press apparatus at pressures of approximately 75 kbar and temperatures of approximately 1500° C. During the step 32, the substrate may be used as a source to introduce the catalyst, such as cobalt, during the high pressure high temperature condition. In a step 34, the polycrystalline diamond material may be treated to remove a portion of the catalyst material to form a polycrystalline diamond body that has an effective transition zone sandwiched between a first polycrystalline diamond zone having substantially free of a catalyst material and a second polycrystalline element zone rich in the catalyst material, wherein the effective transition zone has a plurality of irregular projections toward the first polycrystalline element zone and the second polycrystalline element zone.

In the step 34, a leaching agent, such as a combination of acid solution, for example, may be used. A group of techniques comprising of elevated temperature, elevated pressure, ultrasonic energy, and combination thereof, may be used in the step 34. In one exemplary embodiment, the step of treating may comprise removing the catalyst material in an elevated temperature by using a leaching agent; and slowly cooling down the leaching agent and the polycrystalline diamond material. In a treatment step 34, a catalyst, such as cobalt metal or its alloys, may be removed from the surface layer of the cutter by chemical etching in an acid solution, for example, in a mixture of nitric and hydrofluoric acids, and subsequent cooling down to room temperature and cleaning of etching debris in water. In another exemplary embodiment, the treating step may further include masking a part of polycrystalline diamond material, such as masking a part at a top surface of the polycrystalline diamond material; and removing the catalyst material in an elevated temperature by using a leaching agent.

The PDC cutting element 12 may be inserted into a fixture (not shown) so that a protected portion 38 (shown in FIG. 2) which includes substrate 20 and a part of polycrystalline diamond volume 12 (shown in FIG. 2) is covered by the fixture, while a portion 36 (shown in FIG. 2) to be leached remains outside of the fixture.

According to an exemplary embodiment, the fixture may be formed from polytetrafluoroethylene (PTFE). The PTFE may be unfilled or filled. In other embodiments, the fixture may be formed from related organic polymers, such as other fluoropolymers or fluoroplastics. Filled PTFE may be filled with one or more of glass, molybdenum sulfide, bronze, acetal, carbon, such as graphite or carbon nanofibers, metal, metal oxides, mica, polyphenylene sulfide, and ceramic fillers, such as BaWO₄. Filled PTFE may also be Rulon®. Rulon® is a registered trademark of Saint-Gobain Performance Plastics Corporation (Paris, France). The precise chemical composition of Rulon® is not publicly available. Another filled PTFE may be Amilon™, a graphite, glass, molybdenum sulfide, or carbon filled PTFE made by Plastomer Technologies (Houston, Tex.). The precise chemical composition of Amilon™ is also not publicly available.

Fillers are typically added to PTFE to improve one or more of its properties. Accordingly, appropriate fillers for filled PTFE used in the fixture may be identified by adding the filler to PTFE, forming a fixture from it, and testing the fixture for the desired property or for its general ability to protect non-leached portion. Such tests may be performed under actual leaching conditions or approximate conditions. Similar tests may be used to identify other suitable fluoropolymers or fluoroplastics.

Without limiting the mechanism of the invention, PTFE may function well as a fixture material due to its resistance to chemical reaction with acidic and caustic substances. The strong Carbon-Fluorine bond in PTFE allows Fluorine to form a non-reactive sheath surrounding the carbon chain. PTFE is also highly crystalline, making it difficult to dissolve. At present, there is no known solvent for PTFE. This general-non-reactivity of PTFE may allow the fixture to withstand leaching process conditions and to be reused multiple times. Furthermore, the fixture may be able withstand leaching conditions for long periods of time or at high temperature or pressure. In certain embodiments, other fluoropolymers or fluoroplastics selected for use as fixture may have a similarly low chemical reactivity with leaching agents and low solubility.

Also without limiting the mechanism of the invention, PTFE may additionally function well as a fixture material due to its low wetting properties. PTFE has a wetting angle of 0, which means that water and aqueous solutions have virtually no tendency to move along PTFE via capillary action. In the context of the current disclosure, this means that leaching agents effectively do not wick into the space between the fixture and protected portion of PDC element 12. Other fluoropolymers or fluoroplastics selected for use as the fixture may similarly have a wetting angle of near zero.

The fixture may be formed by processing the protective material to the desired configuration. In one embodiment, PTFE may be processed by heating granules of it to above 325° C., at which point it becomes a self-supporting gel that may be pressed, extruded, or sintered. In general, PTFE may be cut, bored or machined to very close tolerances. In selected embodiments, rather than being made entirely of PTFE, the fixture may merely be coated entirely or in part with PTFE or it may contain a PTFE portion.

The fixture may have an interior cavity that generally conforms to the shape of PDC cutting element 12. Due to the low wetting angle of PTFE (or other low wetting angle protective materials), the fixture may alternatively have an interior cavity that is larger than the dimensions of PDC element 12. In such an embodiment, only contact band may conform to the shape of PDC element 12. Due to the nearly complete absence of capillary action of water on PTFE, only a small, close-fitting contact band may be sufficient to substantially prevent the leaching agent from reaching protected portion. Furthermore, the high resilience of PTFE may allow the contact band to fit very closely to PDC cutting element 12 and, in certain embodiments, to conform to the surface of PDC cutting element 12. Contact band may also be formed to precise tolerances, enhancing its ability to interface with PDC cutting element 12 in a manner to form a seal and substantially prevent wicking of the leaching agent.

In one particular embodiment, contact band may be formed from PTFE or other protective material and the exterior of the fixture may be coated with PTFE or other protective material, but the core of the fixture may be formed from another material, which optionally may not be coated in the interior cavity.

The use of a larger interior cavity in the fixture may offer various advantages, such as use of less PTFE or other protective material or greater ease of removal of PDC element 12 from the fixture after leaching. It is noted, however, that due to the low coefficient of friction of PTFE, neither insertion nor removal of PDC element 12 into or out of the fixture tends to require substantial force. In most instances, the PDC element 12 may be inserted or removed by hand.

PDC cutting element 12 may be any type of element to be leached, including a cutter as shown in FIGS. 1 and 2. Leached portion may typically be formed entirely of PDC. Protected, non-leached portion may include some PDC; particularly PDC located at the interface of the PDC and substrate, and may also typically include the substrate.

### EXAMPLE 1

### Non-Linear Leached Interface in a PDC Cutter

A PDC cutter was produced under a high pressure high temperature method. Specifically, diamond particles having an average diameter of approximately 20 microns were loaded into a can material with a cobalt cemented tungsten carbide substrate having a non-flat interface. The materials were loaded into a high pressure/high temperature cell and pressed in a belt press apparatus at pressures of approximately 75 kbar and temperatures of approximately 1500° C. The resulting cutter had a range of diamond grain size averaged around 20 microns, surrounded by cobalt rich metal regions of varying size between the diamond grains.

The pressed cutter was finished to 16 mm in diameter with a diamond thickness of 2.1 mm, and a height of 8 mm. The cutter was then bonded to a tungsten carbide bonding stud to reach the overall height of 13 mm. A 45 degree chamfer was placed on the edge of the diamond at a thickness of 0.4 mm.

The cutter was then placed in a PTFE fixture and leached in the conventional way to a depth of 300 microns. The majority of metal residing in the interstices between the diamond grains was removed by an acid etching process. In this case, the acid consisted of a mixture of concentrated nitric acid, hydrochloric acid, and hydrofluoric acid in a volume ratio of 3:9:4 respectively. To accelerate the leach, the acid mixture was heated to just below the boiling point, namely 185 F. The leaching process was carried out over the period of 72 hours. At the end of the specified leaching time, conventionally, the cutters were removed from the hot acid and thoroughly washed to remove acid from the surface.

The cutters were cooled gradually in the acid, allowing for a range of chemical activity and diffusion rates of the acid within the leach pores of the cutter. Specifically, allowing the cutter/fixture to reside in the acid for 2.5 hours during which time the temperature of the acid was gradually cooled from the normal leaching temperature of 185 F to room temperature, nominally 70 F. This gradual adjusting of the activity and diffusion in the system allowed for the leaching process to continue in larger leach pores for an extended period of time while smaller leach pores were slowed dramatically.

PDC cutters produced in this way were cut in half and examined in the scanning electron microscope (SEM) in back scattered electron mode to show clear differentiation of the presence of metal or lack of metal, thereby allowing for an examination of the interface between the leached and unleached PDC regions.

As shown in FIG. 4A, in conventionally leached PDC cutters of this type, the effective transition zone (ETZ), defined as the length between the highest peak of the projections toward the first polycrystalline element zone and lowest valley of the projections toward the second polycrystalline element zone, was on the order of one to two times of the diamond grain size. With a diamond grain size of approximately 20 microns, the ETZ of a conventionally leached cutter was on the order of 20-40 microns.

As shown in FIG. 4B, when the PDC cutters were leached using the method described in the exemplary embodiment, the EFT 28 was on the order of three to five times of the grain size. There was a plurality of irregular projections 29, rich in catalyst material toward the first polycrystalline element. There was a plurality of irregular projections or valleys 31 toward the second polycrystalline element, with substantially free of the catalyst material. The plurality of projections 29 and 31 were randomly distributed by nature of the random pore size distribution. This translated to 60-100 microns, for example, between the highest and lowest leached points in the center region of the cutter. From the observed microstructure, the EFT for this example was 80 microns.

### EXAMPLE 2

### Abrasion Testing of Non-Linear Leach Interface

An exemplary embodiment provided a high abrasion resistance cutter suitable for use in drilling and machining applications. Cutters produced as described in Example 1 have been tested on a vertical torrent lathe (VTL) and show an improvement in abrasion resistance over cutters conventionally leached to the same depth. It is believed that this is due to two factors. Firstly, the larger EFT allows for a more gradual distribution of elastic properties in the cutting structure than a sharp, conventional interface between leached and unleached PDC cutter. This non-linear transition distributes the applied stress and thermally generated stress more gradually than a sharp transition between leached and unleached. Secondly, the cutter from Example 1 experienced a decrease in the amount of chipping observed in the test. This reduced chipping allowed for a smoother cutting surface, resulting in increased abrasion resistance.

### EXAMPLE 3

### Drop Test of Non-Linear Leach Interface

Cutters produced as described in Example 1 were dropped onto tungsten carbide in a standard drop test configuration. These cutters showed signs of cracking around the point of impact, but these cracks did not propagate far enough into the PDC cutter to lead to a large scale spallation of the leached diamond layer due to the undulating nature of the interface. When a conventionally leached cutter of the same leach depth is dropped in the same configuration, large regions of the leached diamond spall off of the surface. With the near-linear conventional interface, there is little resistance to crack propagation along the weakened plane of the interface.

### EXAMPLE 4

### Interrupted Mill Test

Cutters were produced as described in Example 1. Samples with conventional and non-linear leach interfaces of nominally the same leach depth were tested in an interrupted mill test. In this test, the cutter was used to machine granite without the use of coolant, resulting in high heat generation in the cutter. Cutters were scored based on the number of passes across the 16″ rock before the cutter fails. Failure is determined as the cutter wearing through the diamond table and into the carbide, at which point, the heat generated rapidly increases. The conventionally leached cutter ran 4.53 passes before failure. The cutter of the disclosed invention ran 16.67 passes before failure, showing a significant improvement in the thermal stability of the resulting cutter.

### EXAMPLE 5

### Masked Leaching to Provide Non-Linear Leaching Interface

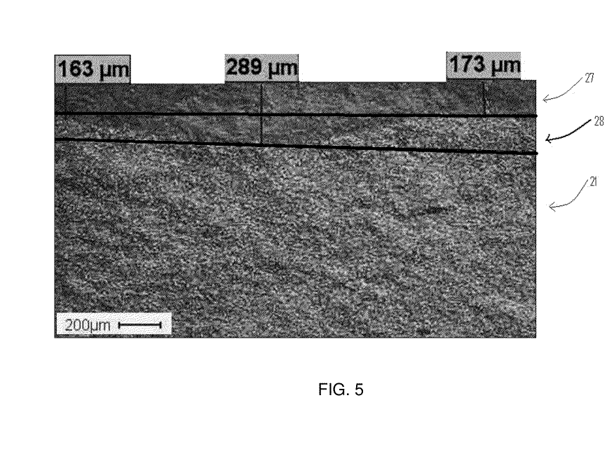

Cutters were produced as described in Example 1, but prior to leaching process, a pattern of PTFE was applied to the top surface of the cutter. The applied pattern was designed not to prevent the leaching under the masked area, but rather to slow the leaching in the diamond immediately under this masked regions by partially obstructing the pathway for the acid to access this region. In this example, a thin ring of PTFE was painted onto the top surface of the cutter. After PTFE layer was cured, the cutter was placed in the fixture and underwent the conventional leaching process described in Example 1. Cutters were sectioned and examined in the SEM in back scattered electron mode as shown in FIG. 5

The result was a non-linearity in the transition from the first polycrystalline element having substantially free of a catalyst material 27 (leached zone) to the second polycrystalline element zone rich in the catalyst material 21 (unleached zone) which is regular and patterned by the mask. In the present example, the masking was used to create a sinusoidal leach front with a period of about 2 mm and an EFT of 126 microns.

Although described in connection with preferred embodiments thereof, it will be appreciated by those skilled in the art that additions, deletions, modifications, and substitutions not specifically described may be made without departure from the spirit and scope of the invention as defined in the appended claims.

While reference has been made to specific embodiments, it is apparent that other embodiments and variations can be devised by others skilled in the art without departing from their spirit and scope. The appended claims are intended to be construed to include all such embodiments and equivalent variations.

What is claimed is:

1. A cutting element, comprising:
a first polycrystalline element zone having substantially free of a catalyst material;
a second polycrystalline element zone rich in the catalyst material; and
an effective transition zone sandwiched between the first polycrystalline element zone and the second polycrystalline element zone, wherein the effective transition zone ranges from about 50 to about 120 microns.

2. The cutting element of claim 1, wherein the effective transition zone comprises a plurality of irregular projections toward the first polycrystalline element zone and the second polycrystalline element zone.

3. The cutting element of claim 2, wherein the effective transition zone measures a distance between a highest peak of the projections toward the first polycrystalline element zone and a lowest valley of the projections toward the second polycrystalline element zone.

4. The cutting element of claim 1, wherein the catalyst material is present as a sintering aid in manufacture of the first and the second polycrystalline element zones.

5. The cutting element of claim 1 further comprises a substrate configured to attach to the second polycrystalline element zone.

6. The cutting element of claim 5, wherein the substrate is a cemented carbide substrate.

7. The cutting element of claim 4, wherein the sintering aid is a member selected from the group comprising of cobalt, nickel, and iron.

8. The cutting element of claim 1, wherein first or second polycrystalline element zone comprises a material selected from a group of polycrystalline cubic boron nitride, polycrystalline diamond and polycrystalline diamond composite materials including diamond doped with elements selected from a group comprising of N, B, P, Si, and S.

9. The cutting element of claim 2, wherein the plurality of irregular projections toward the first polycrystalline element zone are rich in the catalyst material.

10. The cutting element of claim 2, wherein the plurality of irregular projections toward the second polycrystalline element zone have substantially free of the catalyst material.

11. A method, comprising the steps of:
subjecting a plurality of diamond crystals to a high pressure and high temperature condition in the presence of a catalyst material to form a polycrystalline diamond material; and
treating the polycrystalline diamond material to remove a portion of the catalyst material to form a polycrystalline diamond body that has an effective transition zone sandwiched between a first polycrystalline diamond zone having substantially free of a catalyst material and a second polycrystalline element zone rich in the catalyst material, wherein the effective transition zone has a plurality of irregular projections toward the first polycrystalline element zone and the second polycrystalline element zone.

12. The method of claim 11, wherein the effective transition zone ranges from about 50 to about 120 microns deep.

13. The method of claim 11, wherein the step of treating comprises using a leaching agent and is selected from a group of techniques comprising of using elevated temperature, using elevated pressure, using ultrasonic energy, and combinations thereof.

14. The method of claim 11, wherein the step of treating comprises:
removing the catalyst material in an elevated temperature by using a leaching agent; and
slowly cooling down the leaching agent and the polycrystalline diamond material.

15. The method of claim 11, wherein during the step of subjecting, a substrate is used as a source to introduce the catalyst material during the high pressure high temperature condition.

16. The method of claim 13, wherein the leaching agent is a combination of acid solution.

17. The method of claim 11, wherein the step of treating comprises:
masking a part of polycrystalline diamond material; and
removing the catalyst material in an elevated temperature by using a leaching agent.

18. The method of claim 17, wherein the step of masking comprises masking a part at a top surface of the polycrystalline diamond material.

19. A cutting element, comprises:
a substrate;
a first polycrystalline diamond zone having substantially free of a catalyst material; and
a second polycrystalline diamond zone rich in the catalyst material, bonded to the substrate along an interface, wherein the second polycrystalline diamond zone bonded to the first polycrystalline diamond zone along an effective transition zone, wherein the effective transition zone has a plurality of irregular projections toward the first polycrystalline diamond zone and the second polycrystalline diamond zone.

20. The cutting element of claim 19, where the effective transition zone measures a distance between a highest peak of the projections toward the first polycrystalline element zone and a lowest valley of the projections to the second polycrystalline element zone.

21. The cutting element of claim 19, wherein the substrate is a cemented carbide substrate.

22. The cutting element of claim 19, wherein the plurality of irregular projections toward the first polycrystalline element zone have the catalyst material.

23. The cutting element of claim 19, wherein the plurality of irregular projections toward the second polycrystalline element zone have substantially free of the catalyst material.

24. The cutting element of claim 19, wherein the effective transition zone ranges from about 50 to about 120 microns.
